(19) United States
(12) Patent Application Publication
(10) Pub. No.: US 2008/0125107 A1
(43) Pub. Date: May 29, 2008

(54) TRANSPARENT ENFORCEMENT OF BLUETOOTH ENCRYPTION

(75) Inventors: Christian Zechlin, Herne (DE); Julien Courthial, Herten (DE); Markus Simmer, Dortmund (DE); Mark Fowlie, N. Copenhagen (DK)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/564,693

(22) Filed: Nov. 29, 2006

(51) Int. Cl. H04Q 7/20; H04M 1/00

(52) U.S. Cl. 455/422.1; 455/550.1

(57) ABSTRACT

A system and method for automatically controlling the enforcement of security in a wireless transaction. In a short-range wireless medium, such as Bluetooth™, a device (e.g., a client) may transmit information to another device (e.g., a server) over a wireless connection. If circumstances permit, security may be automatically enabled, or a request to enable security may automatically be issued, so that the information is exchanged in a secure manner.

### BACKGROUND OF INVENTION

1. Field of Invention

The present invention relates to a system for managing wireless communication between two or more devices, and more specifically, to the automatic establishment of security provisions when transferring information from one wireless communication device to another.

2. Description of Prior Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices (WCDs) have become commonplace for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate WCD communication over large geographic areas. These network technologies have commonly been divided by generations, starting in the late 1970s to early 1980s with first generation (1G) analog cellular telephones that provided baseline voice communication, to modem digital cellular telephones. GSM is an example of a widely employed 2G digital cellular network communicating in the 900 MHZ/1.8 GHZ bands in Europe and at 850 MHz and 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth™ is an example of a short-range wireless technology quickly gaining acceptance in the marketplace. A Bluetooth™ enabled WCD transmits and receives data at a rate of 720 Kbps within a range of 10 meters, and may transmit up to 100 meters with additional power boosting. A user does not actively instigate a Bluetooth™ network. Instead, a plurality of devices within operating range of each other will automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master, and wait for an active slot to become available. These devices continually switch between various active communication and power saving modes in order to transmit data to other piconet members. In addition to Bluetooth™, other popular short-range wireless networks include WLAN (of which “Wi-Fi” local access points communicating in accordance with the IEEE 802.11 standard, is an example), WUSB, UWB, ZigBee (802.15.4, 802.15.4a), and UHF RFID. All of these wireless mediums have features and advantages that make them appropriate for various applications.

More recently, manufacturers have also begun to incorporate various resources for providing enhanced functionality in WCDs (e.g., components and software for performing close-proximity wireless information exchanges). Sensors and/or readers may be used to read visual or electronic information into a device. A transaction may involve a user holding their WCD in proximity to a target, aiming their WCD at an object (e.g., to take a picture) or sweeping the device over a printed tag or document. Machine-readable technologies such as radio frequency identification (RFID), Infra-red (IR) communication, optical character recognition (OCR) and various other types of visual, electronic and magnetic scanning are used to quickly input desired information into the WCD without the need for manual entry by a user.

Device manufacturers are continuing to incorporate as many of the previously identified exemplary communication features as possible into wireless communication devices in an attempt to bring powerful, “do-all” devices to market. Devices incorporating long-range, short-range and machine readable communication resources also often include multiple wireless mediums or radio protocols for each category. For example, a user may utilize a multifunction WCD to replace traditional tools such as individual phones, facsimile machines, computers, storage media, etc. which tend to be more cumbersome to both integrate and transport.

With the incorporation of so many functions into a single device, the wireless exchange of information from one device to another has become commonplace. For example, desired information may be exchanged in a standardized format, such as the vCard file format utilized for exchanging electronic business card information and the vCalendar format (now superseded by the iCalendar format) for appointment scheduling. These standard information formats allow a multitude of devices running different applications to quickly share information.

However, the convenience realized by these standard protocols may, in some instances, also lead to problems. Many of these protocols for exchanging wireless information may be enhanced with security features, such as encryption, but often these security features are optional. Security enforcement may not be required because in many cases, for example two professionals wirelessly exchanging contact information saved in their mobile devices, the need to manually enable/disable security, enter a password, etc. could be both inconvenient and possibly embarrassing in certain business situations. The result of not requiring security measures like encryption is that frequently no security is implemented in these transactions. Unsecured information being transmitted wirelessly may be intercepted by an unknown third party. The intercepted information could be used for malicious purposes, or may be altered and retransmitted before getting to its target, such as in the case of a man-in-the-middle attack.

What is therefore needed is a system and method for automatically enabling security measures when transferring data. The enablement of these security measures should be premised on whether a secure connection can be established with little or no manual intervention from either party involved in the transaction. If security can be enabled under these conditions, then security is enforced. Otherwise, the transaction proceeds without security (e.g., encryption).

### SUMMARY OF INVENTION

The present invention includes at least a system and method for automatically controlling the enforcement of security in a wireless transaction. In a short-range wireless medium, such as Bluetooth™, a device (e.g., client) may transmit information to another device (e.g., a server) over a wireless connection. If circumstances permit, security may be automatically enabled, or a request to enable security may automatically be issued, so that the information is exchanged in a secure manner.

In at least one embodiment of the present invention as it pertains to short-range wireless communication mediums like Bluetooth™, a connection may be negotiated between at least a server device and a client device. When information is pushed from server to client, a determination is made whether the devices were previously known to each other (e.g., linked in trusted pair). If these two devices were previously paired, and as a result specific link keys exist in one or both devices, then encryption may automatically be enabled in the wireless transaction. If the devices were not previously paired, then the transaction may proceed without encryption.

Further, if the at least two devices are known to each other and were previously linked as a trusted pair, an inquiry may be issued in one or both of the devices involved in the transaction. The inquiry may include a message on the user interface of a WCD announcing that security is available and asking whether to enable security for the transaction. One or both of the users may then respond. If either response requests security to be enabled, then the wireless transaction may be encrypted. Otherwise, security will not be activated in the wireless exchange.

### DESCRIPTION OF DRAWINGS

The invention will be further understood from the following detailed description of a preferred embodiment, taken in conjunction with appended drawings, in which:

FIG. 1 discloses an exemplary wireless operational environment, including wireless communication mediums of different effective range.

FIG. 2 discloses a modular description of an exemplary wireless communication device usable with at least one embodiment of the present invention.

FIG. 3 discloses an exemplary structural description of the wireless communication device previously described in FIG. 2.

FIG. 4 discloses an exemplary operational description of a wireless communication device including further detail regarding a Bluetooth™ protocol stack in accordance with at least one embodiment of the present invention.

FIG. 5 discloses additional detail regarding the Bluetooth™ Profiles section of the exemplary Bluetooth™ protocol stack disclosed in FIG. 4 in accordance with at least one embodiment of the present invention.

FIG. 6A discloses an exemplary Object Push Profile transaction in accordance with at least one embodiment of the present invention.

FIG. 6B discloses additional detail regarding the exemplary Object Push Profile transaction of FIG. 6A in accordance with at least one embodiment of the present invention.

FIG. 7 discloses an example of an alternative Object Push Profile transaction in accordance with at least one embodiment of the present invention.

FIG. 8 discloses a flow chart for an exemplary communication transaction process in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

### I. Wireless Communication Over Different Communication Networks

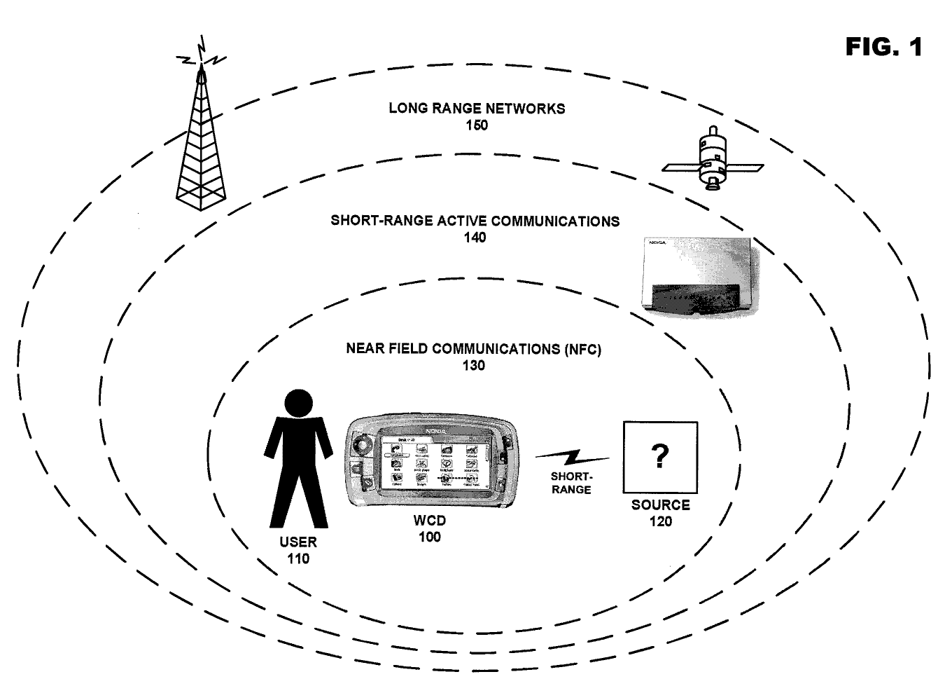

A WCD may both transmit and receive information over a wide array of wireless communication networks, each with different advantages regarding speed, range, quality (error correction), security (encoding), etc. These characteristics will dictate the amount of information that may be transferred to a receiving device, and the duration of the information transfer. FIG. 1 includes a diagram of a WCD and how it interacts with various types of wireless networks.

In the example pictured in FIG. 1, user 110 possesses WCD 100. This device may be anything from a basic cellular handset to a more complex device such as a wirelessly enabled palmtop or laptop computer. Near Field Communication (NFC) 130 includes various transponder-type interactions wherein normally only the scanning device requires its own power source. WCD 100 scans source 120 via short-range communication. A transponder in source 120 may use the energy and/or clock signal contained within the scanning signal, as in the case of RFID communication, to respond with data stored in the transponder. These types of technologies usually have an effective transmission range on the order of ten feet, and may be able to deliver stored data in amounts from 96 bits to over a megabit (or 125 Kbytes) relatively quickly. These features make such technologies well suited for identification purposes, such as to receive an account number for a public transportation provider, a key code for an automatic electronic door lock, an account number for a credit or debit transaction, etc.

The transmission range between two devices may be extended if both devices are capable of performing powered communication. Short-range active communication 140 includes applications wherein the sending and receiving devices are both active. An exemplary situation would include user 110 coming within effective transmission range of a Bluetooth™, WLAN, UWB, WUSB, etc. access point. In the case of Wibree™, a network may automatically be established to transmit information to WCD 100 possessed by user 110. Wibree™ may be used for battery-powered devices, such as wireless sensors, since its power consumption is low. A Wibree™ device may use the advertisement mode to more rapidly establish the initial connection to WCD 100. This data may include information of an informative, educational or entertaining nature. The amount of information to be conveyed is unlimited, except that it must all be transferred in the time when user 110 is within effective transmission range of the access point. This duration may be extremely limited if the user is, for example, strolling through a shopping mall or walking down a street. Due to the higher complexity of these wireless networks, additional time is also required to establish the initial connection to WCD 100, which may be increased if many devices are queued for service in the area proximate to the access point. The effective transmission range of these networks depends on the technology, and may be from some 30 ft. to over 300 ft. with additional power boosting.

Long-range networks 150 are used to provide virtually uninterrupted communication coverage for WCD 100. Land-based radio stations or satellites are used to relay various communication transactions worldwide. While these systems are extremely functional, the use of these systems is often charged on a per-minute basis to user 110, not including additional charges for data transfer (e.g., wireless Internet access). Further, the regulations covering these systems may cause additional overhead for both the users and providers, making the use of these systems more cumbersome.

### II. Wireless Communication Device

As previously described, the present invention may be implemented using a variety of wireless communication equipment. Therefore, it is important to understand the communication tools available to user 110 before exploring the present invention. For example, in the case of a cellular telephone or other handheld wireless devices, the integrated data handling capabilities of the device play an important role in facilitating transactions between the transmitting and receiving devices.

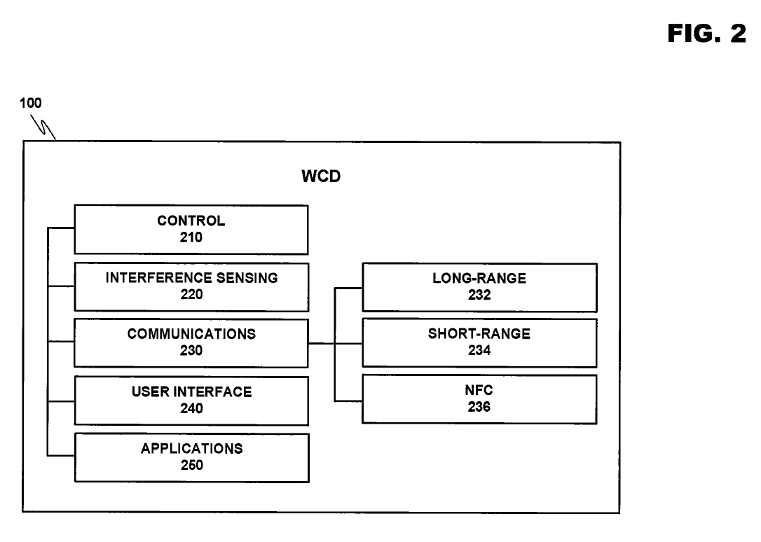

FIG. 2 discloses an exemplary modular layout for a wireless communication device usable with the present invention. WCD 100 is broken down into modules representing the functional aspects of the device. These functions may be performed by the various combinations of software and/or hardware components discussed below.

Control module 210 regulates the operation of the device. Inputs may be received from various other modules included within WCD 100. For example, interference sensing module 220 may use various techniques known in the art to sense sources of environmental interference within the effective transmission range of the wireless communication device. Control module 210 interprets these data inputs, and in response, may issue control commands to the other modules in WCD 100.

Communications module 230 incorporates all of the communication aspects of WCD 100. As shown in FIG. 2, communications module 230 may include, for example, long-range communications module 232, short-range communications module 234 and machine-readable data module 236 (e.g., for NFC). Communications module 230 utilizes at least these sub-modules to receive a multitude of different types of communication from both local and long distance sources, and to transmit data to recipient devices within the transmission range of WCD 100. Communications module 230 may be triggered by control module 210, or by control resources local to the module responding to sensed messages, environmental influences and/or other devices in proximity to WCD 100.

User interface module 240 includes visual, audible and tactile elements which allow the user 110 to receive data from, and enter data into, the device. The data entered by user 110 may be interpreted by control module 210 to affect the behavior of WCD 100. User-inputted data may also be transmitted by communications module 230 to other devices within effective transmission range. Other devices in transmission range may also send information to WCD 100 via communications module 230, and control module 210 may cause this information to be transferred to user interface module 240 for presentment to the user.

Applications module 250 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

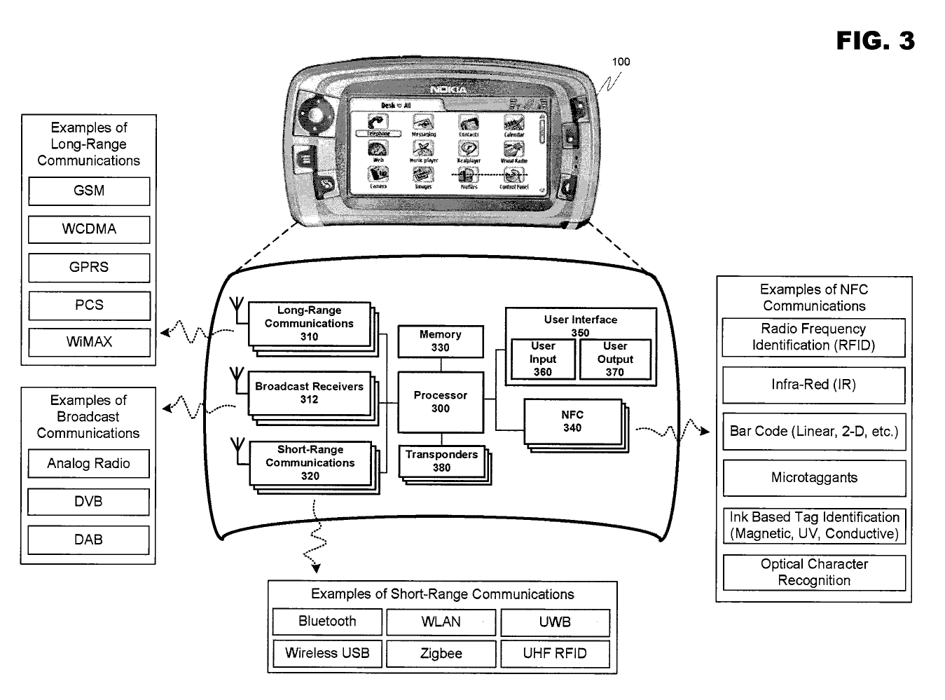

FIG. 3 discloses an exemplary structural layout of WCD 100 according to an embodiment of the present invention that may be used to implement the functionality of the modular system previously described in FIG. 2. Processor 300 controls overall device operation. As shown in FIG. 3, processor 300 is coupled to at least communications sections 310, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

The software components stored by memory 330 include instructions that can be executed by processor 300. Various types of software components may be stored in memory 330. For instance, memory 330 may store software components that control the operation of communication sections 310, 320 and 340. Memory 330 may also store software components including a firewall, a service guide manager, a bookmark database, user interface manager, and any communication utilities modules required to support WCD 100.

Long-range communications 310 performs functions related to the exchange of information over large geographic areas (such as cellular networks) via an antenna. These communication methods include technologies from the previously described 1G to 3G. In addition to basic voice communication (e.g., via GSM), long-range communications 310 may operate to establish data communication sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages.

As a subset of long-range communications 310, or alternatively operating as an independent module separately connected to processor 300, transmission receiver 312 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 320 is responsible for functions involving the exchange of information across short-range wireless networks. As described above and depicted in FIG. 3, examples of such short-range communications 320 are not limited to Bluetooth™, Wibree™, WLAN, UWB and Wireless USB connections. Accordingly, short-range communications 320 performs functions related to the establishment of short-range connections, as well as processing related to the transmission and reception of information via such connections.

Short-range input device 340, also depicted in FIG. 3, may provide functionality related to the short-range scanning of machine-readable data (e.g., for NFC). For example, processor 300 may control short-range input device 340 to generate RF signals for activating an RFID transponder, and may in turn control the reception of signals from an RFID transponder. Other short-range scanning methods for reading machine-readable data that may be supported by short-range input device 340 are not limited to IR communication, linear and 2-D (e.g., QR) bar code readers (including processes related to interpreting UPC labels), and optical character recognition devices for reading magnetic, UV, conductive or other types of coded data that may be provided in a tag using suitable ink. In order for short-range input device 340 to scan the aforementioned types of machine-readable data, the input device may include optical detectors, magnetic detectors, CCDs or other sensors known in the art for interpreting machine-readable information.

As further shown in FIG. 3, user interface 350 is also coupled to processor 300. User interface 350 facilitates the exchange of information with a user. FIG. 3 shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device that may be programmed by processor 300 with information to be delivered in response to a scan from an outside source. For example, an RFID reader mounted in an entryway may continuously emit radio frequency waves. When a person with a device containing transponder 380 walks through the door, the transponder is energized and may respond with information identifying the device, the person, etc. In addition, a reader may be mounted (e.g., as discussed above with regard to examples of short-range input device 340) in WCD 100 so that it can read information from other transponders in the vicinity.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communication components stored in memory 330.

The elements shown in FIG. 3 may be constituted and coupled according to various techniques in order to produce the functionality described in FIG. 2. One such technique involves coupling separate hardware components corresponding to processor 300, communications sections 310, 312 and 320, memory 330, short-range input device 340, user interface 350, transponder 380, etc. through one or more bus interfaces (which may be wired or wireless bus interfaces). Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communication utilities software component, also contained in memory 330, which provides for the establishment of service sessions using long-range communications 310 and/or short-range communications 320. The communication utilities component may include various routines that allow the reception of services from remote devices according to mediums such as the Wireless Application Medium (WAP), Hypertext Markup Language (HTML) variants like Compact HTML (CHTML), etc.

### III. Basic Profiles for Wireless Communication.

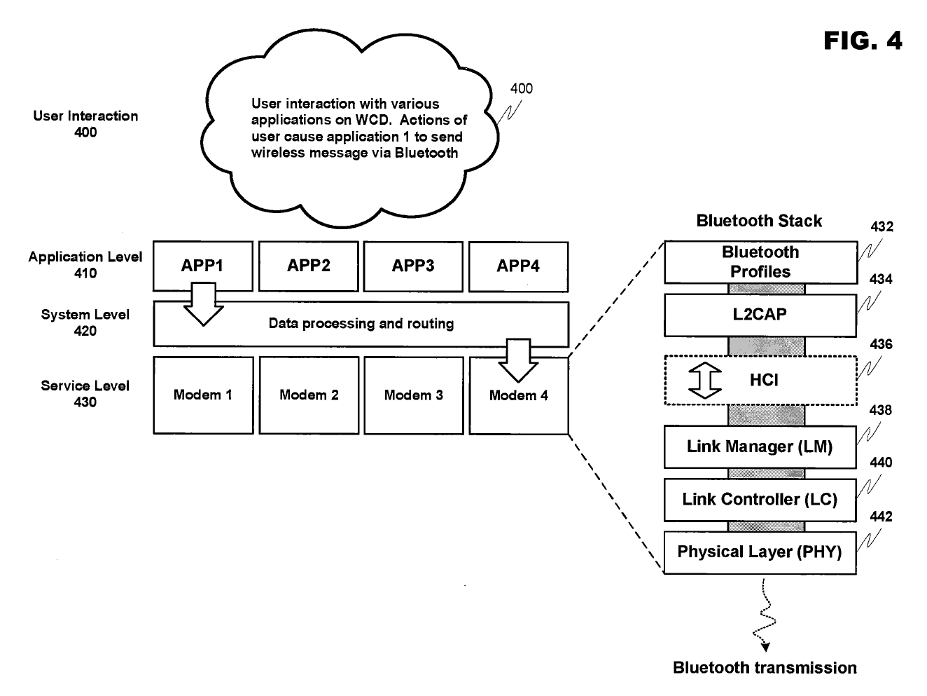

FIG. 4 discloses a stack approach to understanding the operation of a WCD in accordance with at least one embodiment of the present invention. At the top level 400, user 110 interacts with WCD 100. The interaction involves user 110 entering information via user input 360 and receiving information from user output 370 in order to activate functionality in application level 410. In the application level, programs related to specific functionality within the device interact with both the user and the system level. These programs include applications for visual information (e.g., web browser, DVB-H receiver, etc.), audio information (e.g., cellular telephone, voice mail, conferencing software, DAB or analog radio receiver, etc.), recording information (e.g., digital photography software, word processing, scheduling, etc.) or other information processing. Actions initiated at application level 410 may require information to be sent from or received into WCD 100. In the example of FIG. 4, data is requested to be sent to a recipient device via Bluetooth™ communication. As a result, application level 410 may then call resources in the system level to initiate the required processing and routing of data.

System level 420 processes data requests and routes the data for transmission. Processing may include, for example, calculation, translation, conversion and/or packetizing the data. The information may then be routed to an appropriate communication resource in the service level. If the desired communication resource is active and available in the service level 430, the packets may be routed to a radio modem for delivery via wireless transmission. There may be a plurality of modems operating using different wireless mediums. For example, in FIG. 4, modem 4 is activated and able to send packets using Bluetooth™ communication. However, a radio modem (as a hardware resource) need not be dedicated only to a specific wireless medium, and may be used for different types of communication depending on the requirements of the wireless medium and the hardware characteristics of the radio modem.

More specifically, a radio modem operating in service level 430 may, when operating using Bluetooth™, utilize a protocol stack such as further depicted in FIG. 4. The protocol stack includes elements that may convey information from a system level to a physical layer where it may be transmitted wirelessly to another device. At the top level, Bluetooth™ Profiles 432 may include definitions which describe, for example, known peripheral devices which may be connected wirelessly to WCD 100, or standards by which applications may utilize Bluetooth™ in order to engage in wireless communication with a peripheral device. Bluetooth™ profiles of other devices may be established through a pairing procedure, wherein identification and connection information for a peripheral device may be received by WCD 100 through a polling process and then saved in order to expedite the connection to the device at a later time. After the application and/or target peripheral device (or devices) is established, any information to be sent must be prepared for transmission. L2CAP level 434 includes at least a logical link controller and adaptation protocol. This protocol supports higher level protocol multiplexing packet segmentation and reassembly, and the conveying of quality of service information. The information prepared by L2CAP level 434 may then be passed to an application-optional host controller interface (HCI) 436. This layer may provide a command interface to the lower link manager protocol (LMP) layers, link manager (LM) 438 and link controller (LC) 440. LM 438 may establish the link setup, authentication, link configuration and other protocols related to establishing a wireless link between two or more devices. Further, LC 440 may manage active links between two or more devices by handling low-level baseband protocols. Wireless communication may then be established and conducted using the hardware (modem, antenna, etc.) making up physical layer (PHY) 442. The Bluetooth™ protocol stack layers may also be utilized in an order reversed from that disclosed above in order to receive wireless transmissions.

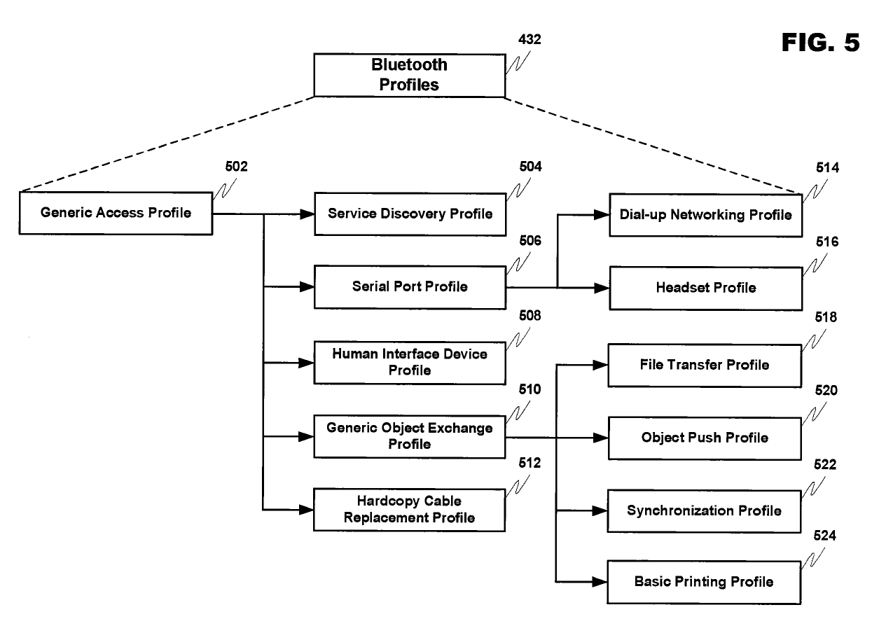

FIG. 5 discloses further detail regarding Bluetooth™ profiles layer 432. The profiles 502-522 define various standardized tasks that may be completed via Bluetooth™ communication. For example, developers may use these profiles in order to make sure that their application will interface correctly with the Bluetooth™. The profiles are organized in a hierarchy, wherein each subsequent profile relies on the definitions in the profile from which it depends. General access profile (GAP) 502 provides the basis for all other profiles and defines a consistent means with which to establish a wireless link between devices (e.g., the device requirements and procedures needed to link the devices, etc.) Under GAP 502 exist basic profiles utilized to establish transactions between two or more devices. Service discovery profile (SDP) 504 delineates how a device should discover services in another device. Serial port profile (SPP) 506 defines how to establish a virtual serial port between two devices. Human interface device profile (HID) 508 defines how various pointing and other user interface devices will wirelessly interact with WCD 100. Generic object exchange profile (GOEP) 510 is the general profile that dictates how objects may be transferred from one device to another, and Hardcopy cable replacement profile (HCRP) 512 defines how driver-based printing is done over a wireless link.

The aforementioned exemplary Bluetooth™ Profiles 423 may be further broken down into more specialized functions. For example, SPP 506 may further incorporate dial-up networking profile (DUN) 514 and headset profile (HSP) 516. DUN 514 may be utilized for accessing the Internet using Bluetooth™ while HSP 516 defines how a Bluetooth™-enabled headset should communicate with WCD 100. Profiles included under GEOP 510 include file transfer profile (FTP) 518, object push profile (OPP) 520, synchronization profile (SYNC) 522 and Basic Printing Profile (BPP) 524. These profiles are all used to define specific instances wherein information is transferred from one device to another device. This information may include files, folders, calendar information, email information, virtual business cards and various other types of electronic information. The information may be pushed to/pulled from a device.

### III. Basic Profiles for Wireless Communication.

It is important to realize that as wireless mediums like Bluetooth™ evolve, that older profiles may be altered and new profiles may evolve based on consumer demand. The profiles previously set forth represent only a small portion of the profiles generally available for interfacing with the wireless medium. Further, the discussion in the present disclosure will be focused on OPP 520. While OPP 520 is a Bluetooth™ profile that may be used with the present invention, the present invention is not specifically limited to only this profile/medium. The present invention may be applicable to any wireless transaction between at least two devices.

OPP 520 may define the roles of a push server device and a push client device. These roles are analogous to, and must interoperate with, the server and client device roles that are previously defined by GOEP 510. It is called “push” because the transfers are always instigated by the sender (client), not the receiver (server). OPP 520 focuses on a narrow range of object formats to maximize interoperability. The most common acceptable format is the vCard. OPP 520 may also be used for sending objects such as pictures, appointment details, etc.

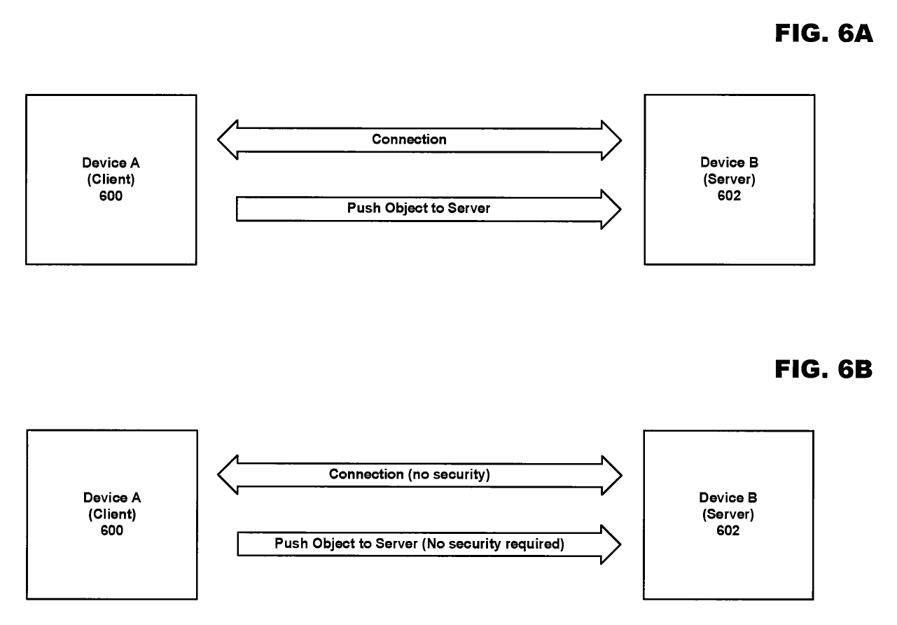

FIG. 6A discloses an exemplary transaction as defined by OPP 520. Device A 600 (hereafter, “client 600”) may transmit or “push” a data object to Device B 602 (hereafter, “server 602”). Client 600 and server 602 may be, for example, communication devices similar to WCD 100. Client 600, after a connection is established, may push an object (e.g., a vCard or iCalendar information) to server 602. In a push transaction, client 600 may both initiate the connection with the server and then push the object to the server. The object, if in accordance with a standard format, may then be quickly assimilated into applications running on client 600.

FIG. 6B follows the example given in FIG. 6A and offers additional detail. Client 600 is pushing information to server 602 in accordance with OPP 520. However, this example specifies that no security is required (e.g., no encryption). Each profile defines some security requirements, but there is no “property” in a transaction to dictate whether a link should be secure. Instead, each device in the transaction is free to initiate the enabling of a secure link.

The implications of this transaction are that information is transmitted without any security measures in place, allowing the information to be intercepted by other listening wireless devices within transmission range of server 602. A third party receiving this information could possibly use it for malicious intent. For example, if the information is sensitive or confidential, such as personal identification information, billing information, credit card information, etc., the third party could use it to impersonate the sending party or possibly to purchase items with their credit card. This situation is also a good scenario for a “man-in-the-middle” attack, wherein the wireless communication device of the third party could intercept, change and rebroadcast the information before it reaches client 600. The attack results in client 600 receiving erroneous or fraudulent information from the third party device instead of the expected object pushed from server 602. With these examples in mind, enabling security whenever possible seems beneficial.

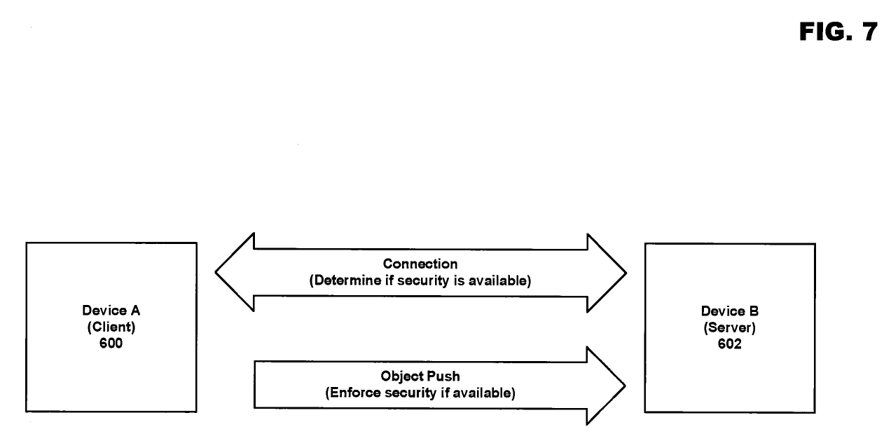

Now referring to FIG. 7, the previously set forth data transaction is improved in accordance with at least one embodiment of the present invention. In this example employing OPP 520, client 600 is again pushing information to server 602. However, in this scenario client 600 is also attempting to determine if security is available, such as encrypting the object push message. Encryption may be available, for example, when the devices have been previously paired. When two devices have already been established as a pair, passkeys and/or other authenticating means have already been used in initially establishing a connection and generating the corresponding link key or association information. This reusable information may be retained on the devices so that client 600 and server 602 may quickly authenticate to each other and encrypt the link during subsequent connections. In this example, after client 600 determines that the devices have been previously paired, the devices may both activate stronger security by encrypting the object push message so that only server 600 may interpret it. Alternatively, if the devices have not been previously paired, and no other security measures are available, the transaction may proceed as requested without any encryption being implemented.

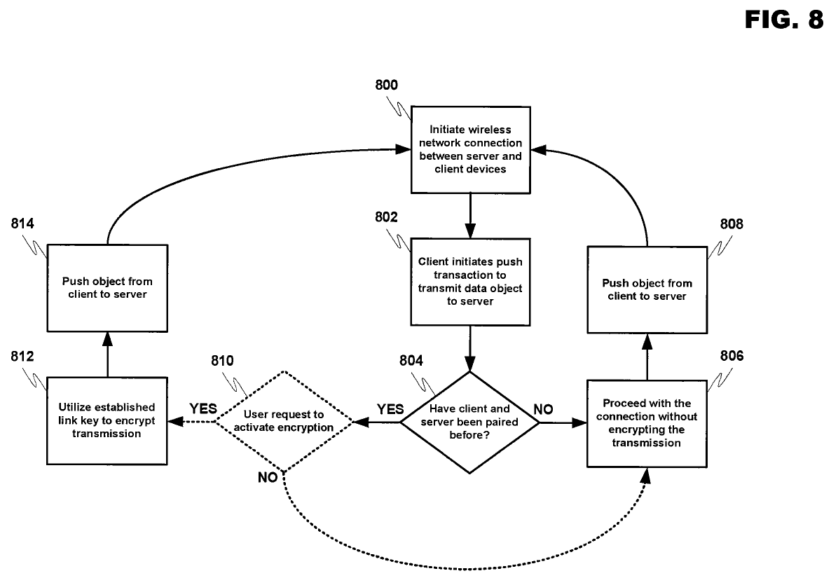

FIG. 8 further discloses an exemplary process flow diagram in accordance with at least one embodiment of the present invention. In step 800 a connection is established between client 600 and server 602. This connection may be a new connection (e.g., the devices are encountering each other for the first time) or the devices may have previously been paired. After the connection is established, client 600 may initiate a transaction to push a data object to server 602 in step 802. If these devices have not been paired before (as determined in step 804) then the transaction may proceed without any security provisions (provided that the higher layers do not enforce security provisions for this connection) in step 806, which results in the object being pushed from the server to the client in step 808.

If in step 804 it is determined that these devices have been paired previously, then an optional step 810 may occur. In this optional step a message is displayed on the user interface of one or both client 600 and server 602 that alerts the users of these devices that security (e.g., encryption) is available and inquires whether to implement it for this transaction. If either user replies affirmatively (to require encryption) then security may be activated in step 810. Otherwise, the transaction may proceed as previously discussed with respect to step 806. If either user requests encryption, or if step 810 is not utilized so that encryption may occur automatically when available, then in step 812 established link key information may be used to encrypt the OPP 520 transaction and push the object from server to client (step 814).

The present invention is an improvement over existing systems in at least one benefit that may be realized in automatically enabling security in a wireless transaction when information required for message encryption/decryption already exists. In this way a transaction may be secured, if possible, without inconveniencing and/or possibly even embarrassing a user of a wireless communication device.

Accordingly, it will be apparent to persons skilled in the relevant art that various changes in form and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
establishing a wireless network connection;
determining whether information required for enabling security is available;
if the information is available, securing messages before transmission; and
if the information is not available, transmitting unsecured messages.

2. The method of claim 1, wherein the wireless network connection is negotiated over a short-range wireless medium.

3. The method of claim 1, wherein determining whether information required for enabling security is available includes determining whether link key information exists for devices coupled via the wireless network connection.

4. The method of claim 3, determining whether link key information exists for devices coupled via the wireless network connection includes determining whether the devices coupled via the wireless network connection were previously paired.

5. The method of claim 3, further comprising displaying a message on a user interface of at least one of the devices coupled via the wireless network connection asking whether to enable security when transmitting messages.

6. The method of claim 1, wherein securing messages before transmission includes at least encrypting the message.

7. A computer program product comprising a computer usable medium having computer readable program code embodied in said medium, comprising:
a computer readable program code for establishing a wireless network connection;
a computer readable program code for determining whether information required for enabling security is available;
if the information is available, a computer readable program code for securing messages before transmission; and
if the information is not available, a computer readable program code for transmitting unsecured messages.

8. The computer program product of claim 7, wherein the wireless network connection is negotiated over a short-range wireless medium.

9. The computer program product of claim 7, wherein determining whether information required for enabling security is available includes determining whether link key information exists for devices coupled via the wireless network connection.

10. The computer program product of claim 9, determining whether link key information exists for devices coupled via the wireless network connection includes determining whether the devices coupled via the wireless network connection were previously paired.

11. The computer program product of claim 9, further comprising displaying a message on a user interface of at least one of the devices coupled via the wireless network connection asking whether to enable security when transmitting messages.

12. The computer program product of claim 7, wherein securing messages before transmission includes at least encrypting the message.

13. A device, comprising:
a communication module enabled to establish a wireless network connection;
a processing module, coupled to the communication module, the processing module being enabled to determine whether information required for enabling security is available;
if the information is available, one or both of the communication module and the processing module further being enabled to secure messages before transmission; and
if the information is not available, one or both of the communication module and the processing module further being enabled to transmit unsecured messages.

14. The device of claim 13, wherein the wireless network connection is negotiated over a short-range wireless medium.

15. The device of claim 13, wherein determining whether information required for enabling security is available includes determining whether link key information exists for devices coupled via the wireless network connection.

16. The device of claim 15, determining whether link key information exists for devices coupled via the wireless network connection includes determining whether the devices coupled via the wireless network connection were previously paired.

17. The device of claim 15, further comprising displaying a message on a user interface of at least one of the devices coupled via the wireless network connection asking whether to enable security when transmitting messages.

18. The device of claim 13, wherein securing messages before transmission includes at least encrypting the message.

19. A device, comprising:
a communication means for establishing a wireless network connection;
a processing means, coupled to the communication means, the processing means for determining whether information required for enabling security is available;
if the information is available, one or both of the communication means and the processing means for securing messages before transmission; and
if the information is not available, one or both of the communication means and the processing means for transmitting unsecured messages.

20. A system, comprising:
a server device;
a client device;
the server device and client device establishing a wireless network connection;
the client device determining whether information required for enabling security is available for communication between the client device and the server device;
if the information is available, the client device securing messages before transmission to the server device; and
if the information is not available, the client device transmitting unsecured messages to the server device.

21. A method, comprising:
establishing a wireless network connection;
receiving notification of an incoming message transmission;
determining whether information required for enabling security is available;
if the information is available, requesting that the incoming message transmission be secured; and
if the information is not available, receiving an unsecured incoming message transmission.

22. The method of claim 21, wherein the wireless network connection is negotiated over a short-range wireless medium.

23. The method of claim 21, wherein determining whether information required for enabling security is available includes determining whether link key information exists for devices coupled via the wireless network connection.

24. The method of claim 23, determining whether link key information exists for devices coupled via the wireless network connection includes determining whether the devices coupled via the wireless network connection were previously paired.

25. The method of claim 23, further comprising displaying a message on a user interface of at least one of the devices coupled via the wireless network connection asking whether to enable security when transmitting messages.

26. The method of claim 21, wherein securing messages before transmission includes at least encrypting the message.

27. A computer program product comprising a computer usable medium having computer readable program code embodied in said medium, comprising:
a computer readable program code for establishing a wireless network connection;
a computer readable program code for receiving notification of an incoming message transmission;
a computer readable program code for determining whether information required for enabling security is available;
if the information is available, a computer readable program code for requesting that the incoming message transmission be secured; and
if the information is not available, a computer readable program code for receiving an unsecured incoming message transmission.

28. The computer program product of claim 27, wherein the wireless network connection is negotiated over a short-range wireless medium.

29. The computer program product of claim 27, wherein determining whether information required for enabling security is available includes determining whether link key information exists for devices coupled via the wireless network connection.

30. The computer program product of claim 29, determining whether link key information exists for devices coupled via the wireless network connection includes determining whether the devices coupled via the wireless network connection were previously paired.

31. The computer program product of claim 29, further comprising displaying a message on a user interface of at least one of the devices coupled via the wireless network connection asking whether to enable security when transmitting messages.

32. The computer program product of claim 27, wherein securing messages before transmission includes at least encrypting the message.

33. A device, comprising:
a communication module enabled to establish a wireless network connection and receive notification of an incoming message transmission;
a processing module, coupled to the communication module, the processing module being enabled to determine whether information required for enabling security is available;
if the information is available, one or both of the communication module and the processing module further being enabled to request that the incoming message transmission be secured; and
if the information is not available, one or both of the communication module and the processing module further being enabled to receive an unsecured incoming message transmission.

34. The device of claim 33, wherein the wireless network connection is negotiated over a short-range wireless medium.

35. The device of claim 33, wherein determining whether information required for enabling security is available includes determining whether link key information exists for devices coupled via the wireless network connection.

36. The device of claim 35, determining whether link key information exists for devices coupled via the wireless network connection includes determining whether the devices coupled via the wireless network connection were previously paired.

37. The device of claim 35, further comprising displaying a message on a user interface of at least one of the devices coupled via the wireless network connection asking whether to enable security when transmitting messages.

38. The device of claim 33, wherein securing messages before transmission includes at least encrypting the message.

39. A device, comprising:
a communication means for establishing a wireless network connection and receive notification of an incoming message transmission;
a processing means, coupled to the communication means, the processing means for determining whether information required for enabling security is available;
if the information is available, one or both of the communication means and the processing means for requesting that the incoming message transmission be secured; and
if the information is not available, one or both of the communication means and the processing means for receiving an unsecured incoming message transmission.

40. A system, comprising:
a server device;
a client device;
the server device receiving notification of an incoming message transmission from the client device;
the server device determining whether information required for enabling security is available for communication between the client device and the server device;
if the information is available, the server device requesting that the incoming message transmission from the client device be secured; and
if the information is not available, the server device receiving an unsecured incoming message transmission from the client device.
